(19) United States
(12) Patent Application Publication
(10) Pub. No.: US 2026/0336997 A1
(43) Pub. Date: Oct. 29, 2026

(54) Control Panel for an Industrial Truck, In Particular a Narrow-Aisle Forklift Truck

(71) Applicant: Linde Material Handling GmbH, Aschaffenburg (DE)

(72) Inventors: Anna Wagner, Rossdorf (DE); Johannes Hössbacher, Aschaffenburg (DE)

(21) Appl. No.: 19/660,514

(22) Filed: Apr. 28, 2026

(30) Foreign Application Priority Data
Apr. 29, 2025 (DE) 102025116446.0

(51) Int. Cl. B66F 9/075

(52) U.S. Cl. CPC B66F 9/0759

(57) ABSTRACT

A control panel for an industrial truck, in particular a narrow-aisle forklift truck, wherein the control panel has at least one control element for controlling the load handling functions of the industrial truck, a control element for controlling the travel function of the industrial truck, a steering control element for controlling the steering function of the industrial truck and a vehicle display for displaying vehicle information. The control panel is provided with a mounting interface for a supply chain management system terminal .

### CROSS-REFERENCE TO RELATED APPLICATION

This application claims priority to German Patent Application No. 102025116446.0 filed Apr. 29, 2025, the disclosure of which is hereby incorporated by reference in its entirety.

### BACKGROUND OF THE INVENTION

### Field of the Invention

The disclosure relates to a control panel for an industrial truck, in particular a narrow-aisle forklift truck, wherein the control panel has at least one control element for controlling the load handling functions of the industrial truck, a control element for controlling the travel function of the industrial truck, a steering control element for controlling the steering function of the industrial truck and a vehicle display for displaying vehicle information.

### Description of Related Art

Industrial trucks configured as narrow-aisle forklift trucks such as swing forklift trucks, high-level stackers or order picking forklift trucks, for example, have an operator's cab in which a control panel is located and wherein the cab can be raised and lowered on the lifting frame. The control panel is provided with at least one control element for controlling the load handling functions of the industrial truck, a control element for controlling the travel function of the industrial truck, a steering control element for controlling the steering function of the industrial truck and a vehicle display for displaying vehicle information.

In customer-side operations, narrow-aisle forklifts of this type such as swing forklift trucks or order picking forklift trucks frequently use a supply chain management system with a supply chain management system terminal located inside the industrial truck, with which the appropriate travel instructions and/or transport work orders are transmitted to the operator, and the receipt of which the operator acknowledges on the supply chain management system terminal. The supply chain management system and the supply chain management system terminal are generally not manufactured by the manufacturer of the forklift truck but by another manufacturer, i.e. by a third-party supplier.

The supply chain management system terminal of the supply chain management system must thereby be installed in the operator's cab so that the travel instructions and/or transport work orders transmitted to the supply chain management system are easily visible to the operator and so that the operator can easily operate the supply chain management system terminal to acknowledge receipt of the travel instructions and/or transport work orders.

For this purpose it is known that the supply chain management system terminal can be located laterally next to the control panel and thus separately or separated from the control panel in the operator's cab.

The control panel is generally located centrally, i.e. in the middle in the transverse direction of the vehicle, on a front parapet wall of the operator's cab, which is associated with load handling means of the industrial truck so that the supply chain management system terminal is located laterally, to the right or the left, next to the control panel on the front parapet wall of the operator's cab.

A location of this type of the supply chain management system terminal laterally, to the right or the left next to the control panel on the front parapet wall of the operator's cab, has the disadvantage that the operator in the operator's cab, while working, must look to the side to see the information on the supply chain management system terminal or to operate the supply chain management system terminal and acknowledge receipt of the travel instructions and/or transport work orders transmitted.

A location of this type of the supply chain management system terminal laterally, to the right or the left next to the control panel on the front parapet wall of the operator's cab, has the further disadvantage that as a result of this placement of the supply chain management system terminal, the operator’s view of the load handling means, for example a load fork with two forks, is adversely affected.

The known solutions for the location of a supply chain management system terminal in the operator's cab of the industrial truck are therefore not optimal for the operator of the industrial truck with regard to ergonomic conditions and visibility on account of the location in which the supply chain management system terminal is installed.

The placement of the supply chain management system terminal on the right or left side next to the control panel on the front parapet wall of the operator's cab therefore results in a poor operating position of the supply chain management system terminal as well as restricted visibility.

### SUMMARY OF THE INVENTION

The object of this disclosure is to make available a control panel of the type cited above that represents an improvement with regard to the above mentioned disadvantages.

This object is accomplished according to the disclosure by providing the control panel with a mounting interface for a supply chain management system terminal.

The control panel therefore has a mounting interface on which the supply chain management system terminal can be mounted directly on the control panel. The mounting interface makes it possible to incorporate the control panel and the supply chain management system terminal into a control unit.

The location of the supply chain management system terminal directly on the control panel has the advantage that the supply chain management system terminal can be located in the optimal control area so that the operator has good visibility of the supply chain management system terminal without having to look to the side to obtain the information on the supply chain management system terminal, and results in optimal accessibility of the supply chain management system terminal for the operator to acknowledge the travel instructions and/or transport work orders transmitted.

Consequently it is not necessary to install the supply chain management system terminal on the front parapet wall, which results in improved visibility of the load handling means for the operator. The location of the supply chain management system terminal directly on the control panel, when the industrial truck is engaged in order-picking operations in which the operator must frequently reach outside the operator’s cab above the front parapet wall does not result in any restrictions or obstacles in the work flow.

According to one advantageous embodiment of the disclosure, the mounting interface of the control panel has an adapter plate on which the supply chain management system terminal can be mounted. By means of a mounting interface in the form of an adapter plate the supply chain management system terminal can be mounted on the control panel in a simple manner.

According to one advantageous embodiment of the disclosure, the mounting interface of the control panel has a least one receptacle boring for a mounting bolt for the mounting of the supply chain management system terminal. A supply chain management system terminal generally has a plurality of threaded borings, for example according to the VESA standard, so that the supply chain management system terminal can be mounted in a simple manner on the control panel with a mounting bolt that extends through the receptacle boring of the mounting interface of the control panel and is screwed into the threaded boring of the supply chain management system terminal.

According to one advantageous embodiment of the disclosure, the mounting interface of the control panel has a clip device and/or a clamp device for the mounting of the supply chain management system terminal. With a clip device and/or a clamp device, the supply chain management system terminal can be mounted on the control panel in a simple manner.

According to one advantageous embodiment of the disclosure, the steering control element is located in a left side area of the control panel and the control element for controlling the travel function of the industrial truck is located in a right side area of the control panel, wherein a cutout, in particular a U-shaped cutout, is configured in a central area between the left side area and the right side area, in which cutout the supply chain management system terminal can be located. As a result, a location of the supply chain management system terminal in the central area of the control panel and therefore between the steering control element and the travel function control element makes possible optimal visibility of the supply chain management system terminal and optimal accessibility of the supply chain management system terminal for the operator.

According to one advantageous embodiment of the disclosure, the vehicle display is located in the central area of the control panel. The operator of the industrial truck can therefore see information on the vehicle display and on the supply chain management system terminal without having to turn his or her head, which results in a further improvement of ergonomic conditions.

According to one advantageous embodiment of the disclosure, an upper side of the supply chain management system terminal is inclined with respect to an upper side of the control panel, in particular by an angle in the range of 110^{°} to 160^{°}.This inclination achieves good legibility of the information on a display of the supply chain management system terminal and minimizes glare.

The disclosure further relates to an industrial truck with a control panel according to the disclosure described above. The industrial truck has the advantages described above, such as the control panel.

The disclosure has a series of advantages:

As a result of the location of the supply chain management system terminal directly on the control panel, the information on the supply chain management system terminal is in the ideal field of vision of the operator of the industrial truck.
As a result of the location of the supply chain management system terminal directly on the control panel, the operator of the industrial truck can interact optimally with the supply chain management system terminal to acknowledge and/or accept new instructions from the supply chain management system terminal. All the relevant information on the supply chain management system terminal is more legible and more accessible to the operator on account of the location of the supply chain management system terminal directly on the control panel, which results in improved ergonomic conditions for the operator.

### BRIEF DESCRIPTION OF THE DRAWINGS

The terms Fig., Figs., Figure, and Figures are used interchangeably in the specification to refer to the corresponding figures in the drawings.

Additional advantages and details of the disclosure are described in greater detail below with reference to the exemplary embodiments illustrated in the accompanying schematic figures, in which:

FIG. 1 shows an industrial truck according to the disclosure in a side view,

FIG. 2 is a plan view showing the control panel of the industrial truck in FIG. 1 with the installed supply chain management system terminal,

FIG. 3 shows the control panel in FIG. 2 without the supply chain management system terminal,

FIG. 4 shows a second embodiment of the control panel, and

FIG. 5 shows the control panel in FIG. 4 with the installed supply chain management system terminal.

### DESCRIPTION OF THE INVENTION

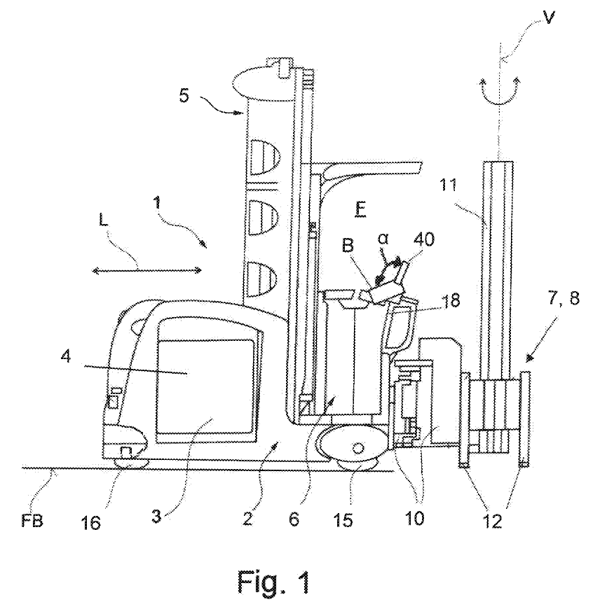

FIG. 1 shows an industrial truck 1 according to the disclosure, which is configured by way of example as a narrow-aisle forklift.

The industrial truck 1 has a vehicle body 2 with a vehicle chassis in which there is a battery compartment 3 for holding a traction battery 4 of an electric battery-powered propulsion system of the industrial truck 1.

The industrial truck 1 has a hoist unit 5 located on the vehicle body 2 and formed by a lifting frame 5, on which, in the illustrated exemplary embodiment, an operator's cab 6 configured as a lift cage or operator's cab which forms an operator’s workplace F for an operator is located so that it can be raised and lowered by means of a hoist unit not illustrated in any further detail. On the operator’s cab 6 that can be raised and lowered, on the illustrated industrial truck 1 there is a load handling arrangement 7 to service shelves located laterally next to the industrial truck 1.

In the illustrated example, the load handling arrangement 7 is configured as a rotating forklift unit 8.

The rotating forklift unit 8 includes a sliding carriage 10 which is located so that it can move in the transverse direction of the vehicle on the operator's cab 6 and thus on the hoist unit 5.

On the load handling arrangement 7 configured as a rotating fork units 8, an auxiliary mast 11 is mounted on the sliding carriage 10 which is movable in the transverse direction of the vehicle by means of a rotary guide and a rotational drive not illustrated in any further detail, so that it can pivot around a vertical axis V relative to the sliding carriage 10. A load fork with two forks is located so that it can be raised and lowered on the auxiliary mast 11.

With the rotary fork unit 8, the movement of the load handling arrangement 7 can be a horizontal reach movement in the transverse direction of the vehicle (sideshift function) and a rotary motion around the vertical axis V, so that shelves on both sides of the industrial truck 1 can be serviced with the rotating forklift unit 8.

In the embodiment shown, the industrial truck 1 has a three-wheel chassis and is supported on a roadway FB by two non-steered and non-driven load wheels 15, which are spaced at some distance from each other in the transverse direction of the vehicle and are located on a load-side end of the vehicle body 2, and a steerable drive wheel 16, which is located on the drive side end of the vehicle body 2 centrally in the transverse direction of the vehicle and at some distance from the load wheels 15 in the longitudinal direction L of the vehicle.

The battery compartment 3 with the traction battery 4 in it is located in the longitudinal direction L of the vehicle between the two load wheels 15 and the drive wheel 16.

In the drive side end of the vehicle body 2 there is also an electrical propulsion system which is not illustrated in any further detail, which includes the electric traction motor and a power steering unit such as, for example, an electric steering motor for the steerable drive wheel 16 and an electrically operated hydraulic pump unit which is provided for the supply of the hydraulic work system, which is formed by the hoist drive of the hoist frame 5 and a hoist drive of the auxiliary mast 11 and the drives (sideshifting device, rotary drive) for the rotary forklift unit 8.

Located in the operator's cab 6 is a control panel B which is provided with the control and operating elements necessary for the operation of the industrial truck 1.

The control panel B is located on a front parapet wall 18 of the operator's cab 6 facing the load handling arrangement 7. The control panel B is preferably located centrally in the transverse direction of the vehicle on the front parapet wall 18 of the operator's cab 6.

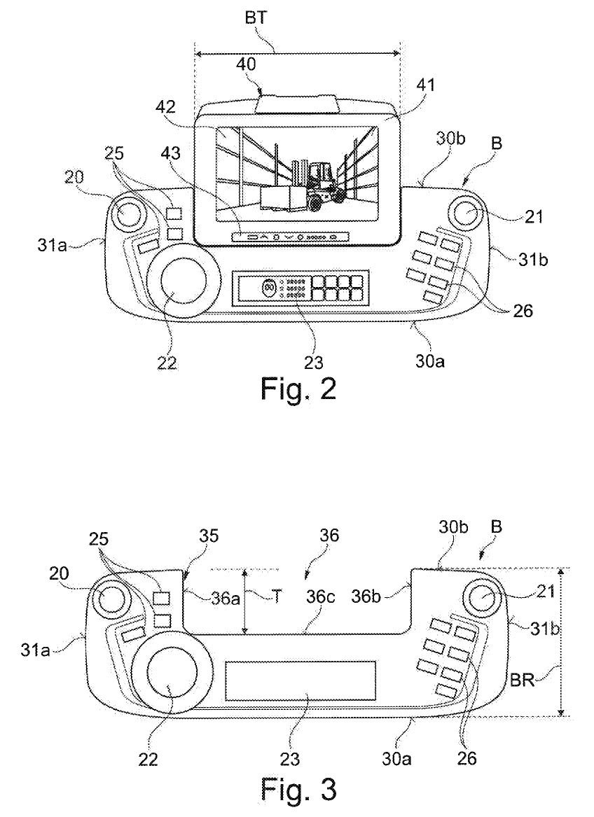

The control panel B in FIG. 1 is illustrated in greater detail in FIGS. 2-5.

The control panel B has a control element 20 for controlling the load handling functions of the industrial truck 1, a control element 21 such as a joystick, for example, for controlling the travel function of the industrial truck 1, a steering control element 22 for controlling the steering function of the industrial truck 1 and a vehicle display 23 for displaying vehicle information of the industrial truck 1.

With the control element 20 for controlling the load handling functions of the industrial truck 1, it is possibly to control, for example, the hoist drive of the operator's cab 6 and of the load handling arrangement 7 as well as the functions (sideshifter device, rotary drive) of the rotary forklift 8. Switch elements 25 with which the functional assignment of the control element 20 can be selected can be located in the area of the control and operating element 20.

The direction of travel and the speed of travel of the industrial truck 1 can be controlled with the control element 21 for controlling the traction function of the industrial truck 1. Switch elements 26 with which the additional functions of the load handling arrangement 7 and/or of the industrial truck 1 can be controlled can be located in the area of the control element 21.

In the illustrated exemplary embodiment, the steering control element 22 for controlling the steering function of the industrial truck is configured as a rotational steering knob.

The purpose of the vehicle display 23 is to display vehicle information of the industrial truck 1, for example operating and vehicle status such as direction of travel, speed of travel, hours of operation, hoist height, load weight of a load being handled and the charge status of the traction battery.

The control panel B, shown in the plan view, has an essentially rectangular shape with a front wall 30a, a rear wall 30b, a left side wall 31a and a right side wall 31b.

When an operator in the operator’s cab 5 is looking at the load handling arrangement 7, the front wall 30a is facing the operator and the rear wall 30b is facing away from the operator.

In a left side area of the control panel B, the steering control element 22 and the control element 20 for controlling the load handling functions of the industrial truck 1 are located so that the steering control element 22 and the control element 20 can be operated with the fingers of the left hand by an operator located in the operator's cab 6 and looking at the load handling arrangement 7.

In a right side area of the control panel B, the control element 21 for controlling the travel function of the industrial truck 1 is located so that the control element 21 can be operated with the fingers of the righthand by an operator located in the operator's cab 6 and looking at the load handling arrangement 7.

The vehicle display 23 is located in a central area of the control panel B located between the left side area and the right side area, in the lower portion facing the front wall 30a.

The control panel B is provided with a mounting interface 35 for a supply chain management system terminal 40.

For this purpose, in the central area of the control panel B between the left side area and the right side area, a cutout 36 is configured, for example a U-shaped cutout, as a component of the mounting interface 35 in which the supply chain management system terminal 40 can be located. The cutout extends from the rear wall 30b of the control panel B toward the front wall 30a of the control panel B and has a depth T that is preferably in the range between 10% and 50% of the width BR of the control panel B. The cutout 36 is adapted to the width BT of the supply chain management system terminal 40 and is delimited by a left boundary wall 36a from the left side area of the control panel B, by means of a right boundary wall 36b from the right side area of the control panel B and by means of a front boundary wall 36c from the central area of the control panel B. The cutout 36 is preferably located centrally in the control panel B, i.e. centrally between the side walls 31a, 31b of the control panel B.

The supply chain management system terminal 40 has a housing 41 and is provided with a display 42 and a control bar 43 which is equipped with corresponding function buttons or function switches.

The cutout 36 forms a rack unit into which the housing 41 of the supply chain management system terminal 40 can be inserted.

FIG. 2 is a plan view of the control panel B with a supply chain management system terminal 40 inserted into the cutout 36.

FIG. 3 shows the control panel B without the supply chain management system terminal 40.

A clip device and/or a clamp device of the mounting interface 35 not illustrated in any further detail can be configured between the boundary walls 36a and 36b and 36c and the housing 41 of the supply chain management system terminal 40 for mounting the supply chain management system terminal 40 inserted into the cutout 36 of the control panel B.

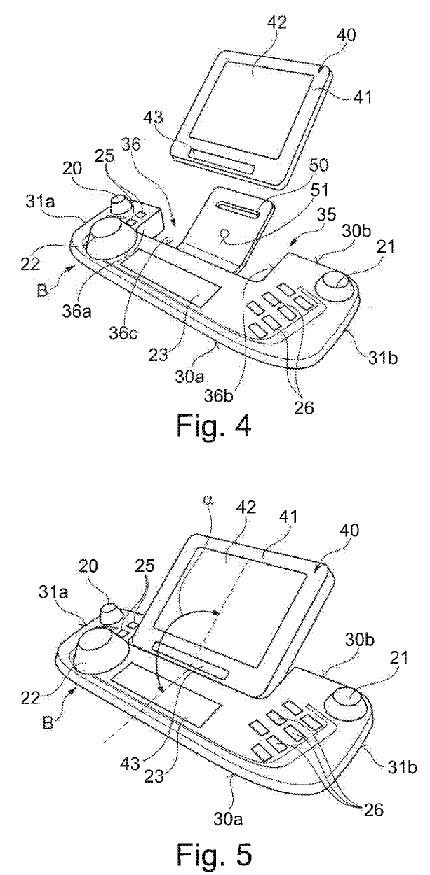

FIGS. 4 and 5 illustrate an additional embodiment of the control panel B. Identical components are identified by identical reference numbers. The control panel B in FIGS. 4 and 5 differs from the embodiment illustrated in FIGS. 2 and 3 with respect to the design of the mounting interface 35 for the supply chain management system terminal 40.

In FIGS. 4 and 5, the mounting interface 35 of the control panel B has an adapter plate 50 on which the supply chain management system terminal 40 can be mounted.

The adapter plate 50 is located in the cutout 36 and the size of the adapter plate 50 is adapted to the dimensions of the supply chain management system terminal 40. The adapter plate 50 is configured so that the supply chain management system terminal 40 can be placed on the adapter plate 50 and fastened to the adapter plate 50.

For this purpose, the adapter plate 50 can have at least one receptacle boring 51 for a mounting bolt which can be bolted into a threaded boring on the back side of the supply chain management system terminal 40 placed on the adapter plate 50. Alternatively, a clip device and/or a clamp device can be configured between the adapter plate 50 and the housing 41 of the supply chain management system terminal 40.

The supply chain management system terminal 40 according to FIGS. 2 and 5 located on the mounting interface 35 of the control panel B is preferably oriented inclined with an upper side on which the display 42 and the control bar 43 are located with respect to an upper side of the control panel B on which the steering control element 22, the control element 20, 21 and the vehicle display 23 are located, by an angle α in the range of 110°^{‏} to 160°. As a result, an optimal viewing angle by the operator located in the operator’s cab 6 of the supply chain management system terminal 40 located on the control panel B can be achieved.

The location of the supply chain management system terminal 40 in the cutout 36 located in the central portion of the control panel B results in ergonomic operation of the supply chain management system terminal 40, because an operator located in the operator’s cab 6 can operate the supply chain management system terminal 40 optionally with the right hand or the left hand.

The location of the supply chain management system terminal 40 in the cutout 36 located in the central portion of the control panel B, wherein the vehicle display 23 is also located in the central portion of the control panel B, further results in good and ergonomic visibility of the display 42 of the supply chain management system terminal 40 because the operator in the operator's cab 6 can change his view between the vehicle display 23 and the display 42 of the supply chain management system terminal 40 without having to look to the side.

The control panel B with the mounting interface 35 for the supply chain management system terminal 40 makes possible an optimal integration of the supply chain management system terminal 40 from a third-party supplier into the control panel B with regard to ease of operation, good visibility and the absence of obstructed views.

An electrical connection of the supply chain management system terminal 40 located on the mounting interface 35 of the control panel B of the industrial truck 1 with a power supply and/or data supply, for example a power connection and/or a data connection, can be accomplished in a simple manner by means of corresponding cable connections.

1. A control panel for an industrial truck, wherein the control panel comprises at least one control element for controlling load handling functions of the industrial truck, a control element for controlling a travel function of the industrial truck, a steering control element for controlling a steering function of the industrial truck and a vehicle display for displaying vehicle information, wherein the control panel is provided with a mounting interface for a supply chain management system terminal.

2. The control panel according to claim 1, wherein the mounting interface has an adapter plate on which the supply chain management system terminal is mounted.

3. The control panel according to claim 1, wherein the mounting interface has at least one receptacle boring for a mounting bolt for mounting the supply chain management system terminal.

4. The control panel according to claim 1, wherein the mounting interface has a clip device and/or a clamp device for mounting the supply chain management system terminal.

5. The control panel according to claim 1, wherein the steering control element is located in a left side area of the control panel and the control element for controlling the travel function of the industrial truck is located in a right side area of the control panel, wherein a cutout , is configured in a central area of the control panel located between the left side area and the right side area, in which cutout the supply chain management system terminal is located.

6. The control panel according to claim 5, wherein the vehicle display is located in the central area.

7. The control panel according to claim 1, wherein an upper side of the supply chain management system terminal is oriented at an angle with respect to an upper side of the control panel.

8. An industrial truck with a control panel according to claim 1.

9. The control panel according to claim 7, wherein the upper side of the supply chain management system terminal is oriented at an angle in the range of 110 degrees to 160 degrees.
